(19) United States
(12) Patent Application Publication
(10) Pub. No.: US 2025/0197535 A1
(43) Pub. Date: Jun. 19, 2025

(54) METHOD OF MANUFACTURING COORDINATION COMPOUND OF RARE-EARTH ELEMENT AND METHOD OF POLYMERIZING CONJUGATED DIENE

(71) Applicant: INDUSTRIAL TECHNOLOGY RESEARCH INSTITUTE, Hsinchu (TW)

(72) Inventors: Feng-Ming HSIEH, Tainan City (TW); Wei Sheng SU, Tainan City (TW); Ting-Yao SU, Pingtung City (TW); Mei-Hua WANG, Tainan City (TW)

(73) Assignee: INDUSTRIAL TECHNOLOGY RESEARCH INSTITUTE, Hsinchu (TW)

(21) Appl. No.: 18/398,670

(22) Filed: Dec. 28, 2023

(30) Foreign Application Priority Data
Dec. 18, 2023 (TW) 112149211

(51) Int. Cl. C08F 4/72; C08F 110/08

(52) U.S. Cl. CPC C08F 4/72; C08F 110/08

(57) ABSTRACT

A method of manufacturing a coordination compound of a rare-earth element includes mixing an oxide of a rare-earth element, a ligand, a C₁₋₃ carboxylic acid, and a C₂₋₆ anhydride to react to form water and a coordination compound of a rare-earth element; and removing the C₁₋₃ carboxylic acid to obtain the coordination compound of a rare-earth element having a water content of less than 100 ppm.

### CROSS REFERENCE TO RELATED APPLICATIONS

The present application is based on, and claims priority from, Taiwan Application Serial Number 112149211, filed on Dec. 18, 2023, the disclosure of which is hereby incorporated by reference herein in its entirety.

### TECHNICAL FIELD

The technical field relates to a method of manufacturing coordination compound of rare-earth element and method of polymerizing conjugated diene.

### BACKGROUND

Coordination compounds of rare-earth elements are critical in the synthesis of high cis diene rubber materials, and their quality will influence the catalytic effect of polymerizing conjugated dienes and the performance of rubber products. A conventional coordination compound of rare-earth elements is manufactured as indicated below. An oxide of a rare-earth element is reacted with hydrochloric acid or nitric acid to form a chloride or nitrate of the rare-earth element, which was then desalted by a sodium salt or ammonium salt of a ligand in an aqueous phase, and then washed with water, extracted by solvent, and purified by distillation to obtain a good-quality coordination compound of the rare-earth element. The above method is related to complex steps of process and purification. In addition, the salt by-product residue of the above method will lower the catalytic effect. The method also includes several water wash and extraction procedures to remove the salt, thereby generating a large amount of waste liquid containing salt.

Accordingly, a method of manufacturing a coordination compound having a low water content is called for to simplify the process and the purification procedures, and to reduce the manufacturing cost and energy consumption.

### SUMMARY

One embodiment of the disclosure provides a method of manufacturing a coordination compound of a rare-earth element, including mixing an oxide of a rare-earth element, a ligand, a C¹⁻³ carboxylic acid, and a C₂₋₆ anhydride to react to form water and a coordination compound of a rare-earth element. The method includes removing the C¹⁻³ carboxylic acid to obtain the coordination compound of a rare-earth element having a water content of less than 100 ppm.

One embodiment of the disclosure provides a method of polymerizing conjugated diene, including using the described coordination compound of a rare-earth element having a water content of less than 100 ppm as a catalyst; and catalyzing a conjugated diene via the catalyst to form a polymer of the conjugated diene.

A detailed description is given in the following embodiments.

### DETAILED DESCRIPTION

In the following detailed description, for the purposes of explanation, numerous specific details are set forth in order to provide a thorough understanding of the disclosed embodiments. It will be apparent, however, that one or more embodiments may be practiced without these specific details.

One embodiment of the disclosure provides a method of manufacturing a coordination compound of a rare-earth element, including: mixing an oxide of a rare-earth element, a ligand, a C₁₋₃ carboxylic acid, and a C₂₋₆ anhydride to react to form water and a coordination compound of a rare-earth element. In some embodiments, the C₂₋₆ anhydride reacts with water to form additional C₁₋₃ carboxylic acid. Subsequently, the C₁₋₃ carboxylic acid is removed to obtain the coordination compound of a rare-earth element having a water content of less than 100 ppm. In some embodiments, the C₁₋₃ carboxylic acid serves as a solvent, and the C₁₋₃ carboxylic acid can be formic acid, acetic acid, propionic acid, or a combination thereof. If the carbon number of the carboxylic acid is too large (e.g. butyric acid or valeric acid), the carboxylic acid will be difficult to be removed by evaporation.

In some embodiments, the C₂₋₆ anhydride may correspond to C₁₋₃ carboxylic acid. The C₁₋₃ carboxylic formed by reacting the C₂₋₆ anhydride and water has a low boiling point and can be easily removed by evaporation. In some embodiments, the C₂₋₆ anhydride may not correspond to the C₁₋₃ carboxylic acid. For example, if the C₁₋₃ carboxylic acid is formic acid, the C₂₋₆ anhydride can be formic anhydride (corresponding to the formic acid), acetic anhydride, propionic anhydride, formic acetic anhydride, formic propionic anhydride, acetic propionic anhydride, or a combination thereof. If the C₁₋₃ carboxylic acid is acetic acid, the C₂₋₆ anhydride can be formic anhydride, acetic anhydride (corresponding to the acetic acid), propionic anhydride, formic acetic anhydride, formic propionic anhydride, acetic propionic anhydride, or a combination thereof. If the C₁₋₃ carboxylic acid is propionic acid, the C₂₋₆ anhydride can be formic anhydride, acetic anhydride, propionic anhydride (corresponding to the propionic acid), formic acetic anhydride, formic propionic anhydride, acetic propionic anhydride, or a combination thereof. It should be understood that the C₂₋₆ anhydride reacts with water to form the C₁₋₃ carboxylic acid, such that the C₂₋₆ anhydride will not be an anhydride of acetic acid and butyric acid or an anhydride of formic acid and valeric acid. As such, the C₂₋₆ anhydride will not react with water to form butyric acid or valeric acid that is difficult to be removed by evaporation in following step.

In some embodiments, the rare-earth element is neodymium. In other embodiments, the rare-earth element can be scandium, yttrium, lanthanum, cerium, praseodymium, samarium, europium, or another suitable rare-earth element. In some embodiments, the oxide of a rare-earth element is Nd₂O₃.

In some embodiments, the ligand is C₅₋₂₅ carboxylic acid or C₁₀₋₅₀ phosphoric acid-based compound. For example, the C₅₋₂₅ carboxylic acid can be neodecanoic acid, oleic acid, or another suitable carboxylic acid. For example, the C₁₀₋₅₀ phosphoric acid-based compound can be

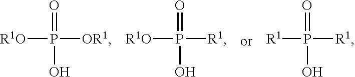

in which each of R¹ is independently C₅₋₂₅ alkyl group, alkenyl group, or aromatic group. In some embodiments, the C₁₀₋₅₀ phosphoric acid-based compound can be di(2-ethylhexyl)phosphoric acid, and its chemical structure is

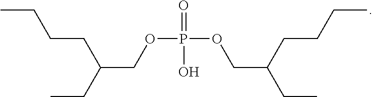 [SMILES: CCCCC(CC)COP(=O)(O)OCC(CC)CCCC]

In some embodiments, the ligand and the rare-earth element have a molar ratio of 2:1 to 6:1. If the ligand amount is too little, the solubility of the coordination compound of a rare-earth element in a low polar solvent will be decreased. If the ligand amount is too much, the catalytic activity of the coordination compound of a rare-earth element will be decreased.

In some embodiments, the C₂₋₆ anhydride and the rare-element have a molar ratio of 3:1 to 8:1. If the amount of the C₂₋₆ anhydride is too low, the effect of removing water will be poor. If the amount of the C₂₋₆ anhydride is too high, it may remaining too much anhydride that is difficult to be removed.

In some embodiments, the C₁₋₃ carboxylic acid is removed by evaporation. In some embodiments, the evaporation can be performed under a reduced pressure to lower the evaporation temperature.

In some embodiments, the coordination compound of a rare-earth element having a water content of less than 100 ppm includes an alkaline metal salt or an ammonium salt of less than 10 ppm, such as 0 ppm.

One embodiment of the disclosure provides a method of polymerizing conjugated diene, including using the described coordination compound of a rare-earth element having a water content of less than 100 ppm as a catalyst; and catalyzing a conjugated diene via the catalyst to form a polymer of the conjugated diene. The coordination compound of a rare-earth element having a lower water content will have a higher catalytic activity under the same reaction condition, and the polymer of the conjugated diene formed with this catalyst will have a higher molecular weight and a narrower polymer dispersity index (PDI). The coordination compound of a rare-earth element having a high water content manufactured by the conventional skill is quickly consumed and has a lower catalytic activity. Moreover, the conventional catalyst easily terminates the polymerization to form a polymer (of the conjugated diene) having a lower molecular weight and a wider PDI. In some embodiments, the conjugated diene can be butadiene, isoprene, another suitable conjugated diene, or a combination thereof. It should be understood that the coordination compound of a rare-earth element having a low water content is not limited to polymerize the conjugated diene, but can be used to polymerize another olefin compound and even be used in another application other than the catalyst for polymerization.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples and Comparative Examples, coordination compounds of neodymium were analyzed by inductively coupled plasma optical emission spectrometer (ICP-OES) to measure their neodymium contents and sodium contents, and analyzed by Karl Fischer moisture titrator to measure their water contents. The catalytic activity of the coordination compounds of neodymium was defined as grams of polybutadiene produced in a catalytic reaction per hour by per mole of neodymium metal.

### Comparative Example 1

A coordination compound of neodymium was manufactured according to the method disclosed in U.S. Pat. No. 4,520,177A. An aqueous solution of neodymium chloride and an aqueous solution of sodium neodecanoate were mixed to react, and then desalted. The theoretical Nd content in the coordination compound of neodymium should be 21.9 wt %, and the Nd content in practice was 20.6 wt %. The product had a water content of 1510 ppm and a sodium content of 492 ppm.

The coordination compound of neodymium was used as a catalyst. Diisobutylaluminum hydride (DIBAH), diethyl aluminum chloride (AlEt2Cl), and triisobutylaluminum (TIBA) were used as co-catalysts. 15 g of butadiene was polymerized in the presence of the catalyst and the co-catalysts. Cyclohexane solutions (10 mL each) of the catalyst and the co-catalysts were prepared, respectively. The catalyst amount was 1.7*10⁻⁵ mol. Nd, DIBAH, AlEt2Cl, and TIBA had a molar ratio of 1:10:3:40. 120 mL of cyclohexane, the solution of the co-catalysts, butadiene, and the solution of catalyst were added into a high pressure reactor to mix, and then heated to 60° C. to react for 1 hour. Subsequently, 5 mL of a methanol solution of butylated hydroxytoluene (BHT, 5%) was added into the reactor to terminate the reaction. The solvent was then removed under a reduced pressure to obtain a polybutadiene product. The product was analyzed by gel-permeation chromatography (GPC) with a standard of polystyrene to measure its molecular weight (MW=268,000) and molecular weight distribution (PDI=2.5). The product dissolved in a solvent of CDCl₃ was analyzed by NMR to measure its cis-structure ratio (97.6%). The catalytic activity was 6.9×10⁵ (g/mol·h).

### Example 1

0.5 g of neodymium oxide was dissolved in 3 mL of acetic acid, and neodecanoic acid and acetic anhydride were then added to the acetic acid solution, in which the neodecanoic acid and neodymium had a molar ratio of 3:1, and the acetic anhydride and neodymium had a molar ratio of 3:1. The solution was heated to 110° C. and stirred to react for 5 hours. The acetic acid was then removed under a reduced pressure to obtain a coordination compound of neodymium (pale purple solid product). The theoretical Nd content in the coordination compound of neodymium was 21.9 wt %, and the Nd content in practice was 21.3 wt %. The product had a water content of 32 ppm and a sodium content of 0 ppm.

The coordination compound of neodymium was used as a catalyst. DIBAH, AlEt2Cl, and TIBA were used as co-catalysts. 15 g of butadiene was polymerized in the presence of the catalyst and the co-catalysts. Cyclohexane solutions (10 mL each) of the catalyst and the co-catalysts were prepared, respectively. The catalyst amount was 1.7*10⁻⁵ mol. Nd, DIBAH, AlEt2Cl, and TIBA had a molar ratio of 1:10:3:40. 120 mL of cyclohexane, the solution of the co-catalysts, butadiene, and the solution of catalyst were added into a high pressure reactor to mix, and then heated to 60° C. to react for 1 hour. Subsequently, 5 mL of a methanol solution of BHT (5%) was added into the reactor to terminate the reaction. The solvent was then removed under a reduced pressure to obtain a polybutadiene product. The product was analyzed by GPC with a standard of polystyrene to measure its molecular weight (MW=323,000) and molecular weight distribution (PDI=1.9). The product dissolved in a solvent of CDCl₃ was analyzed by NMR to measure its cis-structure ratio (98.3%). The catalytic activity was 8.1×10⁵ (g/mol·h).

### Example 2

0.5 g of neodymium oxide was dissolved in 3 mL of acetic acid, and neodecanoic acid and acetic anhydride were then added to the acetic acid solution, in which the neodecanoic acid and neodymium had a molar ratio of 4:1, and the acetic anhydride and neodymium had a molar ratio of 3:1. The solution was heated to 130° C. and stirred to react for 4 hours. The acetic acid was then removed under a reduced pressure to obtain a coordination compound of neodymium (pale purple solid product). The theoretical Nd content in the coordination compound of neodymium was 17.4 wt %, and the Nd content in practice was 17.1 wt %. The product had a water content of 54 ppm and a sodium content of 0 ppm.

The coordination compound of neodymium was used as a catalyst. DIBAH, AlEt2Cl, and TIBA were used as co-catalysts. 15 g of butadiene was polymerized in the presence of the catalyst and the co-catalysts. Cyclohexane solutions (10 mL each) of the catalyst and the co-catalysts were prepared, respectively. The catalyst amount was 1.7*10⁻⁵ mol. Nd, DIBAH, AlEt2Cl, and TIBA had a molar ratio of 1:10:3:40. 120 mL of cyclohexane, the solution of the co-catalysts, butadiene, and the solution of catalyst were added into a high pressure reactor to mix, and then heated to 60° C. to react for 1 hour. Subsequently, 5 mL of a methanol solution of BHT (5%) was added into the reactor to terminate the reaction. The solvent was then removed under a reduced pressure to obtain a polybutadiene product. The product was analyzed by GPC with a standard of polystyrene to measure its molecular weight (MW=314,000) and molecular weight distribution (PDI=1.8). The product dissolved in a solvent of CDCl₃ was analyzed by NMR to measure its cis-structure ratio (97.9%). The catalytic activity was 8.4×10⁵ (g/mol·h).

### Example 3

0.5 g of neodymium oxide was dissolved in 3 mL of acetic acid, and neodecanoic acid and acetic anhydride were then added to the acetic acid solution, in which the neodecanoic acid and neodymium had a molar ratio of 5:1, and the acetic anhydride and neodymium had a molar ratio of 6:1. The solution was heated to 80° C. and stirred to react for 6 hours. The acetic acid was then removed under a reduced pressure to obtain a coordination compound of neodymium (pale purple solid product). The theoretical Nd content in the coordination compound of neodymium was 14.4 wt %, and the Nd content in practice was 14.0 wt %. The product had a water content of 19 ppm and a sodium content of 0 ppm.

### Example 4

0.5 g of neodymium oxide was dissolved in 3 mL of acetic acid, and oleic acid and acetic anhydride were then added to the acetic acid solution, in which the oleic acid and neodymium had a molar ratio of 3:1, and the acetic anhydride and neodymium had a molar ratio of 3:1. The solution was heated to 100° C. and stirred to react for 3 hours. The acetic acid was then removed under a reduced pressure to obtain a coordination compound of neodymium (pale purple solid product). The theoretical Nd content in the coordination compound of neodymium was 14.6 wt %, and the Nd content in practice was 14.5 wt %. The product had a water content of 43 ppm and a sodium content of 0 ppm.

### Example 5

0.5 g of neodymium oxide was dissolved in 3 mL of acetic acid, and di(2-ethylhexyl)phosphoric acid and acetic anhydride were then added to the acetic acid solution, in which the di(2-ethylhexyl)phosphoric acid and neodymium had a molar ratio of 3.3:1, and the acetic anhydride and neodymium had a molar ratio of 3:1. The solution was heated to 130° C. and stirred to react for 3 hours. The acetic acid was then removed under a reduced pressure to obtain a coordination compound of neodymium (pale purple solid product). The theoretical Nd content in the coordination compound of neodymium was 12.0 wt %, and the Nd content in practice was 11.7 wt %. The product had a water content of 26 ppm and a sodium content of 0 ppm.

The coordination compound of neodymium was used as a catalyst. DIBAH and AlEt2Cl were used as co-catalysts. 15 g of butadiene was polymerized in the presence of the catalyst and the co-catalysts. A cyclohexane solution (10 mL) of the catalyst and the co-catalysts was prepared. The catalyst amount was 5.6*10⁻⁶ mol. Nd, DIBAH, and AlEt2Cl had a molar ratio of 1:30:3. The solution was heated to 60° C. to be aged for 2 hours, thereby obtaining a catalyst aging solution. 120 mL of cyclohexane, the catalyst aging solution, and 15 g of butadiene were added into a high pressure reactor to mix, and then heated to 60° C. to react for 2 hour. Subsequently, 5 mL of a methanol solution of BHT (5%) was added into the reactor to terminate the reaction. The solvent was then removed under a reduced pressure to obtain a polybutadiene product. The product was analyzed by GPC with a standard of polystyrene to measure its molecular weight (MW=361,000) and molecular weight distribution (PDI=1.7). The product dissolved in a solvent of CDCl₃ was analyzed by NMR to measure its cis-structure ratio (98.2%). The catalytic activity was 1.1×10⁶ (g/mol·h).

### Comparative Example 2

0.5 g of neodymium oxide was dissolved in 3 mL of acetic acid, and neodecanoic acid was then added to the acetic acid solution, in which the neodecanoic acid and neodymium had a molar ratio of 3:1. The solution was heated to 110° C. and stirred to react for 5 hours. The acetic acid was then removed under a reduced pressure to obtain a coordination compound of neodymium (pale purple solid product). The theoretical Nd content in the coordination compound of neodymium was 21.9 wt %, and the Nd content in practice was 20.8 wt %. The product had a water content of 637 ppm and a sodium content of 0 ppm.

The coordination compound of neodymium was used as a catalyst. DIBAH, AlEt2Cl, and TIBA were used as co-catalysts. 15 g of butadiene was polymerized in the presence of the catalyst and the co-catalysts. Cyclohexane solutions (10 mL each) of the catalyst and the co-catalysts were prepared, respectively. The catalyst amount was 1.7*10⁻⁵ mol. Nd, DIBAH, AlEt2Cl, and TIBA had a molar ratio of 1:10:3:40. 120 mL of cyclohexane, the solution of the co-catalysts, butadiene, and the solution of catalyst were added into a high pressure reactor to mix, and then heated to 60° C. to react for 1 hour. Subsequently, 5 mL of a methanol solution of BHT (5%) was added into the reactor to terminate the reaction. The solvent was then removed under a reduced pressure to obtain a polybutadiene product. The product was analyzed by GPC with a standard of polystyrene to measure its molecular weight (MW=285,000) and molecular weight distribution (PDI=2.2). The product dissolved in a solvent of CDCl₃ was analyzed by NMR to measure its cis-structure ratio (97.8%). The catalytic activity was 7.2×10⁵ (g/mol·h).

### Comparative Example 3

0.5 g of neodymium oxide was added to 3 mL of hexane, and neodecanoic acid and acetic anhydride were then added to the hexane, in which the neodecanoic acid and neodymium had a molar ratio of 3:1, and the acetic anhydride and neodymium had a molar ratio of 3:1. Because the neodymium could not be dissolved in hexane, the effect of the coordination reaction was poor.

As known from the above Examples and Comparative Examples, the coordination compound of neodymium having a lower water content in Examples had a higher catalytic activity, and the polybutadiene formed in the presence of the coordination compound of neodymium in Examples had a higher molecular weight and a narrower PDI. The coordination compound of neodymium having a higher water content in Comparative Examples is consumed faster to lower the catalyst activity, and the polymerization is easily terminated in Comparative Examples to form a polybutadiene with a lower molecular weight and a wider PDI.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A method of manufacturing a coordination compound of a rare-earth element, comprising:
mixing an oxide of a rare-earth element, a ligand, a C₁₋₃ carboxylic acid, and a C₂₋₆ anhydride to react to form water and a coordination compound of a rare-earth element; and
removing the C₁₋₃ carboxylic acid to obtain the coordination compound of a rare-earth element having a water content of less than 100 ppm.

2. The method as claimed in claim 1, wherein the rare-earth element is neodymium.

3. The method as claimed in claim 1, wherein the C₂₋₆ anhydride reacts with water to form additional C₁₋₃ carboxylic acid.

4. The method as claimed in claim 1, wherein the C₂₋₆ anhydride is formic anhydride, acetic anhydride, propionic anhydride, formic acetic anhydride, formic propionic anhydride, acetic propionic anhydride, or a combination thereof.

5. The method as claimed in claim 1, wherein the ligand is C₅₋₂₅ carboxylic acid or C₁₀₋₅₀ phosphoric acid-based compound.

6. The method as claimed in claim 5, wherein the C₁₀₋₅₀ phosphoric acid-based compound is 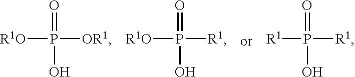
wherein each of R¹ is independently C₅₋₂₅ alkyl group, alkenyl group, or aromatic group.

7. The method as claimed in claim 1, wherein the ligand and the rare-earth element have a molar ratio of 2:1 to 6:1.

8. The method as claimed in claim 1, wherein the C₂₋₆ anhydride and the rare-element have a molar ratio of 3:1 to 8:1.

9. The method as claimed in claim 1, wherein the coordination compound of a rare-earth element having a water content of less than 100 ppm includes an alkaline metal salt or an ammonium salt of less than 10 ppm.

10. A method of polymerizing conjugated diene, comprising:
using the coordination compound of a rare-earth element having a water content of less than 100 ppm manufactured by the method as claimed in claim 1 as a catalyst; and
catalyzing a conjugated diene via the catalyst to form a polymer of the conjugated diene.

11. The method as claimed in claim 10, wherein the conjugated diene comprises butadiene, isoprene, or a combination thereof.
